(19) United States
(12) Patent Application Publication
(10) Pub. No.: US 2006/0173610 A1
(43) Pub. Date: Aug. 3, 2006

(54) Device for making available and/or evaluating navigation data and method for releasing navigation data in a navigation system

(76) Inventor: Holger Listle, Hildesheim (DE)

Correspondence Address: KENYON & KENYON LLP, ONE BROADWAY, NEW YORK, NY, 10004, US

(21) Appl. No.: 10/546,786

(22) PCT Filed: Jan. 7, 2005
(86) PCT No.: PCT/EP05/50056

§ 371 Date: Aug. 24, 2005

(30) Foreign Application Priority Data
Feb. 26, 2004 (DE) 10-2004-009-274.5

(51) Int. Cl. G01C 21/36

(52) U.S. Cl. 701/200

(57) ABSTRACT

A device for providing and/or evaluating navigation data, in particular in motor vehicles, as well as a method for clearing navigation data in navigation systems. An initial license is stored during the manufacture of the device as an authorization for use.

### FIELD OF THE INVENTION

The present invention relates to a device for providing and/or evaluating navigation data, in particular in motor vehicles, having at least an operating device, a processor, and an output device. In addition, the present invention relates to a method for clearing (allowing access to) navigation data in a navigation system having at least one such device.

### BACKGROUND INFORMATION

From the prior art, navigation systems are known that have data carriers having a high storage capacity. These navigation systems are available with a functionality that allows a clearing of navigation data that is selective both temporally and also regionally. An example of such a navigation system is the “C-IQ” system marketed by the company VDO.

A disadvantage of such systems is the fact that already during purchase of the device, registration of the device in a service system is required in order to acquire a corresponding license for the navigation data and to be able to use the navigation data.

On the basis of this prior art, an object of the present invention is to provide a device and a method that enable a more convenient and more versatile use of the navigation data.

### DETAILED DESCRIPTION

The device for providing and/or evaluating navigation data, according to the present invention, provides at least an operating device, a processor, and an output device, so that the navigation data, in particular routes and supplementary information, can be queried, processed, and made accessible to the user. In such a device, an initial license is stored that makes it possible for the user of the device or of the navigation system to have access to a range of data that depends on the initial scope of the license, without registering in a service system. Thus, the user of the navigation system or of the device for providing and evaluating navigation data need no longer carry out an application and registration in a service system, but rather can use the navigation system immediately.

A development of the present invention provides that the initial license has a time limit. In this case, upon initial use the beginning of the period of use is confirmed or is automatically determined, so that the user can access the navigation data immediately after the determination or confirmation. This makes it possible for temporary licenses to be integrated into a device or navigation system so that the user can experience and evaluate the product before acquiring a complete license code, thus obtaining a full license. An initial license is understood as a license that is already stored in a device when it is manufactured and that enables navigation data to be used from the beginning. Such a use from the beginning need not comprise a complete authorization for the use of all navigation data; rather, a user has additional options for alternative or supplementary navigation data or system components. For this reason, it is provided that the initial license permits a use of the navigation data within a limited scope; for example, the navigation data may be limited to a particular region, or additional information may not be outputted, or a particular resolution may not be exceeded, or an additional time limit may be built in. Thus, for example, one possibility is to offer a combination of a device and rights of use of navigation data that permits the use of a navigation system with a corresponding device for a limited region and for a defined period of time.

It is provided that the initial license is implemented during the manufacturing process of the device, and is stored in the device already before the Implementation of the device in a vehicle. The initial license is usefully bound to the device in order to avoid misuse of the licenses.

The method for clearing navigation data in a navigation system as described above or with a device as described above provides that the initial license is stored in the device already during its manufacture, as an authorization for use. Besides the above-described time-limited license, it is possible for the initial license to be assigned without a time limit. In this case, the initial license can be activated as soon as it is integrated into the device or into the navigation device, requiring no interaction with the user, who can then use the device immediately after it is installed. For example, in devices supplied to the user as vehicle equipment by automobile manufacturers (OEM devices), this method allows the contents of a supplied data carrier to be cleared without a time limit. The purchaser of a vehicle acquires, without further interaction, a fully usable system, but with the added possibility of additionally clearing alternative and/or additional navigation data contents. For this purpose, the user would have to employ standard measures in order to obtain additional contents, for example by ordering an expansion of the scope of use via a telephone call in which the device number is indicated.

1-6. (canceled)

7. A device for at least one of providing and evaluating navigation data, comprising:
an operating device;
a processor;
an output device; and
means for storing an initial license authorizing a use of the navigation data.

8. The device according to claim 7, wherein the device is in a motor vehicle.

9. The device according to claim 7, wherein the initial license has a time limit.

10. The device according to claim 7, wherein the initial license permits a use of the navigation data within a limited scope.

11. The device according to claim 7, wherein the initial license is implemented during a manufacturing process of the device, and is stored in the device as part of a navigation system before an initial operation of the device.

12. The device according to claim 7, wherein the initial license is bound to the device.

13. A method for clearing navigation data in a navigation system having a device, the device including an operating device, a processor and an output device, the method comprising:
storing an initial license during a manufacture of the device as an authorization for a use of the navigation data.

14. The method according to claim 13, wherein the method is for vehicle navigation.
